(19) United States
(12) Patent Application Publication
(10) Pub. No.: US 2025/0262488 A1
(43) Pub. Date: Aug. 21, 2025

(54) PICKLEBALL BALL AND A METHOD OF MANUFACTURE THEREOF

(71) Applicant: YOU BETCHA LLC, West Fargo, ND (US)

(72) Inventors: Myles Montplaisir, West Fargo, ND (US); Ryan Sheeley, West Fargo, ND (US); Alan Kasin, Fargo, ND (US)

(21) Appl. No.: 18/444,533

(22) Filed: Feb. 16, 2024

(51) Int. Cl. A63B 45/00; B29C 45/00; B29C 45/16

(52) U.S. Cl. CPC A63B 45/00; B29C 45/0013; B29C 45/0046; B29C 45/006; B29C 45/1634

(57) ABSTRACT

A method of manufacture for a pickleball ball includes injection molding a first hemisphere of the pickleball ball from a base resin; incorporating a colorant into the base resin during the injection molding of the first hemisphere, the colorant of a color different than a color of the base resin to form a first design in the first hemisphere; injection molding a second hemisphere of the pickleball ball from the base resin; incorporating the colorant into the base resin during the injection molding of the second hemisphere, the colorant of the color different than the color of the base resin to form a second design in the second hemisphere; and hot seam welding the first hemisphere to the second hemisphere.

### CROSS REFERENCE TO RELATED APPLICATION

None

### BACKGROUND

The present disclosure relates to a sports ball, and more specifically to a pickleball ball that enhances the interest of the pickleball match and a method of manufacture of the pickleball ball.

The popular sport of pickleball combines several sports such as badminton, tennis, and table tennis. Pickleball balls are often specialized for use indoors or outdoors and are made of a durable material having a smooth surface.

### SUMMARY

A method of manufacture for a pickleball ball according to one disclosed non-limiting embodiment of the present disclosure includes injection molding a first hemisphere of the pickleball ball from a base resin; incorporating a colorant into the base resin during the injection molding of the first hemisphere, the colorant of a color different than a color of the base resin to form a first design in the first hemisphere; injection molding a second hemisphere of the pickleball ball from the base resin; incorporating the colorant into the base resin during the injection molding of the second hemisphere, the colorant of the color different than the color of the base resin to form a second design in the second hemisphere; and hot seam welding the first hemisphere to the second hemisphere.

A further embodiment of any of the foregoing embodiments of the present disclosure includes that the first design and the second design are equivalent patterns.

A further embodiment of any of the foregoing embodiments of the present disclosure includes that the first design and the second design form a random distribution of the colorant within the base resin.

A further embodiment of any of the foregoing embodiments of the present disclosure includes that the first design and the second design form a tortoise shell pattern.

A further embodiment of any of the foregoing embodiments of the present disclosure includes that the first design and the second design form a camouflage pattern.

A further embodiment of any of the foregoing embodiments of the present disclosure includes that the first design and the second design form a marble pattern.

A further embodiment of any of the foregoing embodiments of the present disclosure includes that the first design and the second design form a sparkle pattern.

A further embodiment of any of the foregoing embodiments of the present disclosure includes forming a multiple of apertures in the first hemisphere and a multiple of apertures in the second hemisphere subsequent to the hot seam welding.

A further embodiment of any of the foregoing embodiments of the present disclosure includes that forming a multiple of apertures in the first hemisphere subsequent to forming the first design in the first hemisphere and a multiple of apertures in the second hemisphere subsequent to forming the second design in the second hemisphere.

A further embodiment of any of the foregoing embodiments of the present disclosure includes that the hot seam welding of the first hemisphere to the second hemisphere arranges a multiple of apertures in the first hemisphere with respect to a multiple of apertures in the second hemisphere to form a predetermined pattern of apertures.

A method of manufacture for a pickleball ball according to one disclosed non-limiting embodiment of the present disclosure includes injection molding a pickleball ball from a base resin and a colorant, the colorant of a color different than a color of the base resin to form a pattern; and forming a predetermined pattern of apertures in the pickleball ball subsequent to the injection molding.

A further embodiment of any of the foregoing embodiments of the present disclosure includes that injection molding the pickleball ball comprises injection molding the pickleball ball as a first hemisphere and a second hemisphere.

A further embodiment of any of the foregoing embodiments of the present disclosure includes hot seam welding the first hemisphere to the second hemisphere.

A further embodiment of any of the foregoing embodiments of the present disclosure includes that the pattern comprises one of a tortoise shell pattern, a camouflage pattern, a marble pattern, and a sparkle pattern.

A pickleball ball according to one disclosed non-limiting embodiment of the present disclosure includes a base resin and a colorant, the colorant of a color different than a color of the base resin to form an injection molded pattern; and a predetermined pattern of apertures formed in the pickleball ball subsequent to the formation of the form an injection molded pattern.

A further embodiment of any of the foregoing embodiments of the present disclosure includes that the pickleball ball comprises a first hemisphere hot seam welded to a second hemisphere.

A further embodiment of any of the foregoing embodiments of the present disclosure includes that the pattern comprises one of a tortoise shell pattern, a camouflage pattern, a marble pattern, and a sparkle pattern.

A further embodiment of any of the foregoing embodiments of the present disclosure includes that the pickleball ball comprises a diameter between 2.874-2.972 inches and a weight of 0.78 and 0.935 ounces.

A further embodiment of any of the foregoing embodiments of the present disclosure includes that the predetermined pattern of apertures comprises twenty-six to forty (26-40) apertures.

A further embodiment of any of the foregoing embodiments of the present disclosure includes that the pattern comprises one of a tortoise shell pattern, a camouflage pattern, a marble pattern, and a sparkle pattern.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is an exploded view of a pickleball ball according to one disclosed non-limiting embodiment.

FIG. 2 is a schematic block diagram of a method of manufacture for a pickleball ball.

FIG. 3 is a perspective view of a pickleball ball with a material effect design according to one disclosed non-limiting embodiment.

FIG. 4 is a perspective view of a pickleball ball with a material effect design according to another disclosed non-limiting embodiment.

FIG. 5 is a perspective view of a pickleball ball with a material effect design according to another disclosed non-limiting embodiment.

FIG. 6 is a perspective view of a pickleball ball with a material effect design according to another disclosed non-limiting embodiment.

FIG. 7 is a schematic view of an injection molding system for use with the method of manufacture for the pickleball ball.

### DETAILED DESCRIPTION

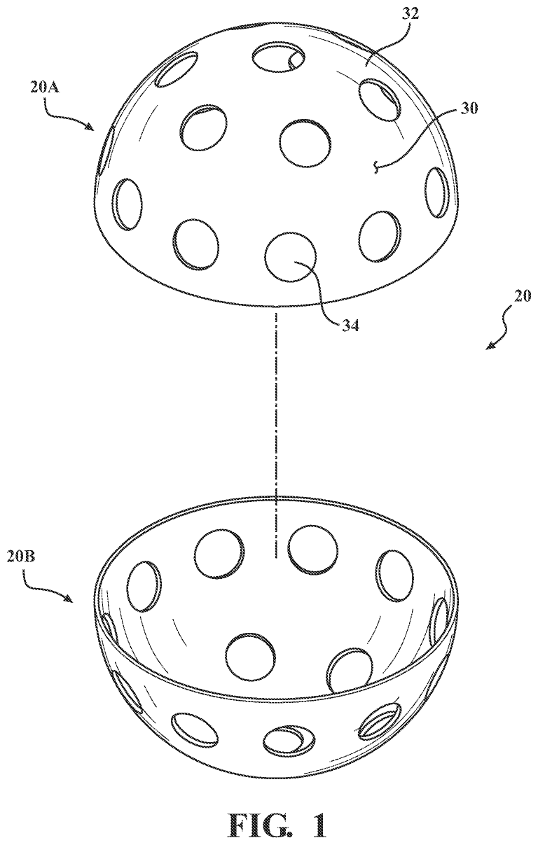

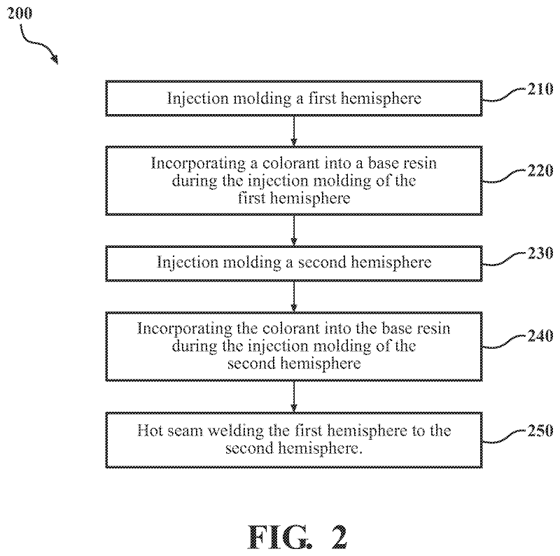

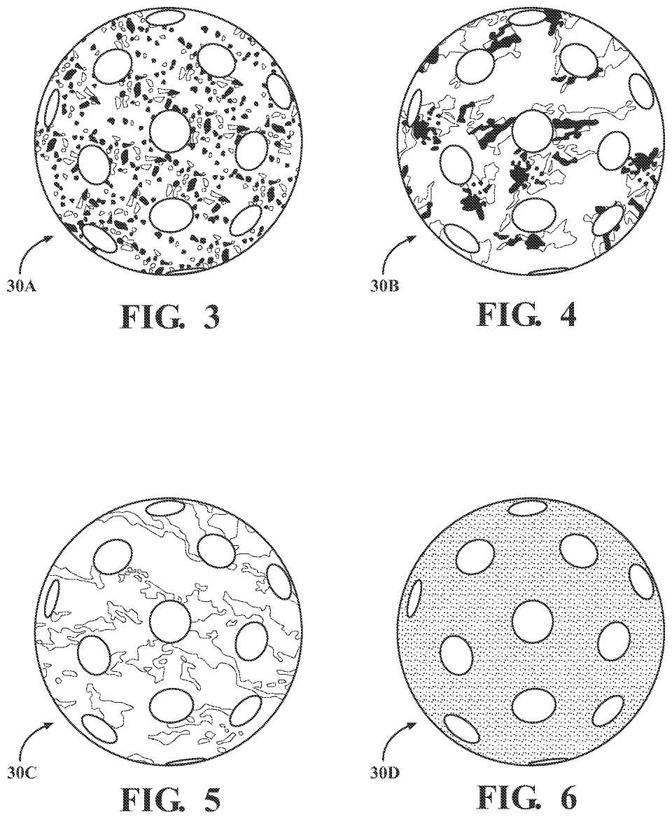

FIG. 1 schematically illustrates a pickleball ball 20 that has one or more material effect designs 30. That is, the pickleball ball 20 has a smooth contiguous surface 32. The pickleball ball 20 is manufactured of two hemispheres 20A, 20B that each typically includes a multiple of apertures 34 that are arranged in a predetermined pattern that facilitates straight flight of the pickleball ball 20. In one embodiment, the pickleball ball 20 has a diameter between 2.874-2.972 inches; a weight of 0.78 and 0.935 ounces, twenty-six to forty (26-40) apertures. Typically, the ball must bounce 30-34 inches when dropped from 78 inches high, and the “out of round variance” cannot be greater than 0.02 inches. The pickleball ball 20 may also vary based on the intended use as indoor pickleballs may be of a softer plastic than outdoor balls. The design 30 is an essentially random distribution of the colorant within the base resin, however, by controlling variables of the injection molding process (FIG. 2) and by dry mixing in the colorant as will be further described, the design 30 may be formed, for example, a tortoise shell design 30A (FIG. 3), a camouflage design 30B (FIG. 4); a marble design 30C (FIG. 5); or a sparkle design 30C (FIG. 6). That is, each design of the hemispheres 20A, 20B are of an equivalent type, however, each of the of the hemispheres 20A, 20B has an essentially random distribution of the colorant. Although particular named designs are illustrated in the disclosed embodiments, it should be appreciated that other such designs or patterns may be provided in accord with the instant disclosure.

In one embodiment, the tortoise shell design 30A (FIG. 3) may include a colorant that is 1% up to 20% of a base resin by weight, more specifically, 2% up to 4% of a base resin by weight.

In one embodiment, the camouflage design 30B (FIG. 4) may include a colorant that is 1% up to 20% of a base resin by weight, more specifically, 2% up to 4% of a base resin by weight.

In one embodiment, the marble design 30C (FIG. 5) may include a colorant that is 1% up to 20% of a base resin by weight, more specifically, 2% up to 4% of a base resin by weight.

In one embodiment, the sparkle design 30C (FIG. 6) may include a colorant that is 1% up to 20% of a base resin by weight, more specifically, 2% up to 4% of a base resin by weight.

With reference to FIG. 2, a method 200 of manufacture for the pickleball ball 20 is schematically disclosed in terms of functional block diagrams. Pickleball balls can be used indoors or outdoors and are made of a durable material which forms an essentially smooth surface and no texture.

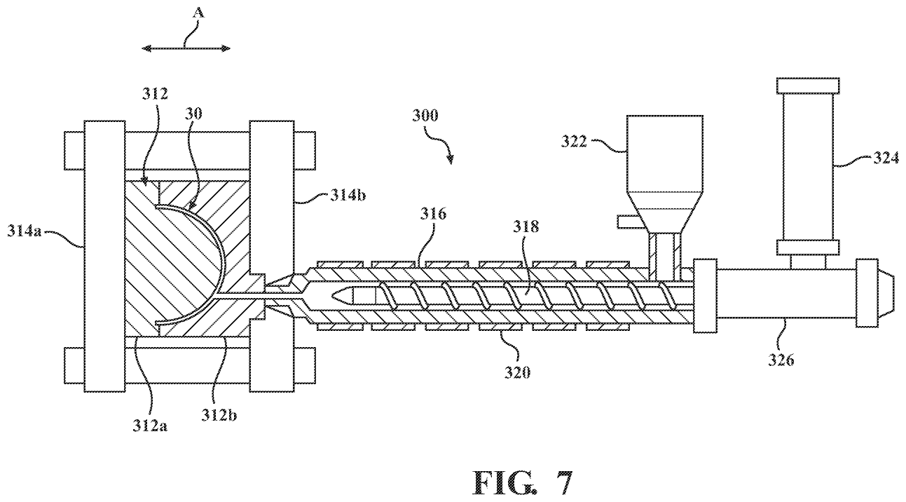

The method 200 of manufacture generally includes injection molding to display the special effects such as via an injection molding system 300 (FIG. 7) of a type commercially available. The injection molding system 300 may include a two-part mold assembly, including opposed separable mold parts 312a and 312b disposed between clamping mechanism components 314a and 314b that form the respective first and second hemisphere of the pickleball ball. That is, the injection molding system 300 injection molds pickleball hemispheres.

The clamping mechanism components 314a and 314b may be moved toward and away from each other in the directions of arrow A. An injection cylinder 316 is suitably connected to the mold assembly 312 and includes an injection screw 318 disposed therein. Suitable heater bands 320 are disposed around the exterior of the injection cylinder 316 for heating the plastic material to be injected into the mold assembly 312. A feed hopper 322 may be provided to hold the appropriate supply of polymer pellets which are then metered into the interior of the injection cylinder 316 where the pellets are heated to a fluid state for injection into the mold. An injection drive unit 326 is operably connected to the injection screw 318 and the injection cylinder 316, and an accumulator 324 is operatively coupled to the injection drive unit 326.

Initially, the method 200 includes injection molding a first hemisphere of the pickleball ball from a base resin (210). The base material may be a thermoplastic powder, plastic, resin, or polymer. In one example, a Polypropylene (PP) material is used. The base resin may be of various base colors, glow in the dark, photochromatic, thermochromic, chroma-shift, and combination thereof.

Next, the colorant is incorporated into the base resin (220) during the injection molding of the first hemisphere. The colorant is of a color different than a color of the base resin to form a first design in the first hemisphere such as the tortoise shell design 30A (FIG. 3), the camouflage design 30B (FIG. 4); the marble design 30C (FIG. 5); or the sparkle design 30C (FIG. 6).

Next, a second hemisphere of the pickleball ball is injection molded from the base resin (230). Typically, a multiple of first hemispheres are injection molded simultaneously, and a multiple of second hemispheres are injection molded simultaneously.

The colorant may be incorporated into the base resin during the injection molding of the second hemisphere (240). The colorant is of the color different than the color of the base resin to form a second design in the second hemisphere. The second design is corresponding to the first design such as the tortoise shell design 30A (FIG. 3), the camouflage design 30B (FIG. 4); the marble design 30C (FIG. 5); or the sparkle design 30C (FIG. 6), That is, the design in each hemisphere may be the same, however, the random nature of the design may result in a difference between the first hemisphere and the second hemisphere once assembled.

Incorporating the colorant into the injection molding process can be performed, in one embodiment, by being blended in with the base resin via dry mixing. Dry mixing involves mixing the colored powder with the base injection molding material before placed into the injection molding machine.

Incorporating the colorant into the injection molding process can be performed, in another embodiment, by being mixed in with the base resin as pellets. That is, the base resin may be formed as pellets and the colorant may be formed as pellets of a different composition which may be mixed together during and/or prior to the injection molding process. The colorant pellets may include a base resin that is of an equivalent or different composition than that of the base resin. In some embodiments, the different compositions prevent blending an allow a pattern to be formed.

Various let down ratios, mixtures, compositions of pellets, mixtures of pellets, temperatures, pressures, etc., may be utilized to form the different patterns, e.g., the tortoise shell design 30A (FIG. 3), the camouflage design 30B (FIG. 4); the marble design 30C (FIG. 5); or the sparkle design 30C (FIG. 6).

The first hemisphere, in one embodiment, may be assembled to the second hemisphere (250) via, for example, hot seam welding to form the smooth contiguous surface 32. The hot seam welding of the first hemisphere to the second hemisphere may be performed to arrange the multiple of apertures 34A in the first hemisphere with respect to the multiple of apertures 34B in the second hemisphere to form the predetermined pattern of apertures 34. That is, the first hemisphere is assembled to the second hemisphere at a particular orientation to assure that the apertures 34 form a predetermined consistent pattern.

In one embodiment, the predetermined pattern of apertures 34 may be formed during the injection molding process. In another embodiment, the predetermined pattern of apertures 34 may be formed, such as by drilling, subsequent to the injection molding process. The example drilling of the predetermined pattern of apertures 34 may be performed prior or subsequent to the hot seam welding to form the smooth contiguous surface 32. Forming the predetermined pattern of apertures 34 subsequent to the injection molding process may advantageously avoid variance to the predetermined consistent pattern proximate the apertures.

The pickleball ball may have a protrusion at the joint portion of the pickle ball as long as it does not significantly affect the straight flight characteristics. The pickle ball may have 26 to 40 circular holes, and the spacing of the holes and the overall design of the pickle ball allows the pickle ball to fly in a straight line.

The design integration on the pickleball ball within the durable material having a smooth surface and no texture enhances the interest of the pickleball match without affecting the flight characteristics of the pickleball ball.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A method of manufacture for a pickleball ball, comprising:
injection molding a first hemisphere of the pickleball ball from a base resin;
incorporating a colorant into the base resin during the injection molding of the first hemisphere, the colorant of a color different than a color of the base resin to form a first design in the first hemisphere;
injection molding a second hemisphere of the pickleball ball from the base resin;
incorporating the colorant into the base resin during the injection molding of the second hemisphere, the colorant of the color different than the color of the base resin to form a second design in the second hemisphere; and
hot seam welding the first hemisphere to the second hemisphere.

2. The method as recited in claim 1, wherein the first design and the second design are equivalent patterns.

3. The method as recited in claim 2, wherein the first design and the second design form a random distribution of the colorant within the base resin.

4. The method as recited in claim 2, wherein the first design and the second design form a tortoise shell pattern.

5. The method as recited in claim 2, wherein the first design and the second design form a camouflage pattern.

6. The method as recited in claim 2, wherein the first design and the second design form a marble pattern.

7. The method as recited in claim 2, wherein the first design and the second design form a sparkle pattern.

8. The method as recited in claim 1, further comprising forming a multiple of apertures in the first hemisphere and a multiple of apertures in the second hemisphere subsequent to the hot seam welding.

9. The method as recited in claim 1, further comprising forming a multiple of apertures in the first hemisphere subsequent to forming the first design in the first hemisphere and a multiple of apertures in the second hemisphere subsequent to forming the second design in the second hemisphere.

10. The method as recited in claim 9, wherein the hot seam welding of the first hemisphere to the second hemisphere arranges a multiple of apertures in the first hemisphere with respect to a multiple of apertures in the second hemisphere to form a predetermined pattern of apertures.

11. A method of manufacture for a pickleball ball, comprising:
injection molding a pickleball ball from a base resin and a colorant, the colorant of a color different than a color of the base resin to form a pattern; and
forming a predetermined pattern of apertures in the pickleball ball subsequent to the injection molding.

12. The method as recited in claim 11, wherein injection molding the pickleball ball comprises injection molding the pickleball ball as a first hemisphere and a second hemisphere.

13. The method as recited in claim 12, further comprising hot seam welding the first hemisphere to the second hemisphere.

14. The method as recited in claim 11, wherein the pattern comprises one of a tortoise shell pattern, a camouflage pattern, a marble pattern, and a sparkle pattern.

15. A pickleball ball, comprising:
a base resin and a colorant, the colorant of a color different than a color of the base resin to form an injection molded pattern; and
a predetermined pattern of apertures formed in the pickleball ball subsequent to the formation of the injection molded pattern.

16. The pickleball ball as recited in claim 15, wherein the pickleball ball comprises a first hemisphere hot seam welded to a second hemisphere.

17. The pickleball ball as recited in claim 15, wherein the pattern comprises one of a tortoise shell pattern, a camouflage pattern, a marble pattern, and a sparkle pattern.

18. The pickleball ball as recited in claim 15, wherein the pickleball ball comprises a diameter between 2.874-2.972 inches and a weight of 0.78 and 0.935 ounces.

19. The pickleball ball as recited in claim 18, wherein the predetermined pattern of apertures comprises twenty-six to forty (26-40) apertures.

20. The pickleball ball as recited in claim 19, wherein the pattern comprises one of a tortoise shell pattern, a camouflage pattern, a marble pattern, and a sparkle pattern.
